(19) United States
(12) Patent Application Publication
(10) Pub. No.: US 2025/0021849 A1
(43) Pub. Date: Jan. 16, 2025

(54) Scalable and Programmable Quantum Control Processor

(71) Applicant: Intel Corporation, Santa Clara, CA (US)

(72) Inventors: Sahar Daraeizadeh, Bellevue, WA (US); Todor Mladenov, Portland, OR (US); Xiang Zou, Portland, OR (US); Anne Matsuura, Portland, OR (US)

(21) Appl. No.: 18/220,212

(22) Filed: Jul. 10, 2023

(51) Int. Cl. G06N 10/20

(52) U.S. Cl. CPC G06N 10/20

(57) ABSTRACT

Apparatus and method for a quantum control processor. For example, one embodiment of a QCP comprises: instruction fetch logic to fetch instructions from a memory, the instructions including quantum instructions; decode logic to decode the quantum instructions into a first plurality of quantum microoperations; translation logic translate the first plurality of quantum microoperations into a second plurality of quantum microoperations based on characteristics of a plurality of quantum controller cores coupled to the quantum control processor; and issue logic to synchronously issue the second plurality of quantum microoperations in parallel to the plurality of quantum controller cores.

### BACKGROUND

### Field of the Invention

The embodiments of the invention relate generally to the field of quantum computing. More particularly, these embodiments relate to a scalable and programmable quantum control processor.

### Description of the Related Art

Quantum computing refers to the field of research related to computation systems that use quantum mechanical phenomena to manipulate data. These quantum mechanical phenomena, such as superposition (in which a quantum variable can simultaneously exist in multiple different states) and entanglement (in which multiple quantum variables have related states irrespective of the distance between them in space or time), do not have analogs in the world of classical computing, and thus cannot be implemented with classical computing devices.

### BRIEF DESCRIPTION OF THE DRAWINGS

A better understanding of the present invention can be obtained from the following detailed description in conjunction with the following drawings, in which:

FIGS. 1A-1F illustrate various views of an example quantum dot device, in accordance with one embodiment;

FIG. 2 illustrates one embodiment of a processor pipeline for processing quantum and non-quantum instructions;

FIG. 3 illustrates an embodiment of front-end circuitry of a processor for processing quantum and non-quantum instructions;

FIGS. 4A-B illustrate embodiments of a quantum-classical processor interface;

FIGS. 5A-B illustrate an example quantum circuit and program code to implement the quantum circuit;

FIGS. 6A-B illustrate an example in which quantum instructions are generated by a compiler, decoded into uops, and executed within a quantum execution engine;

FIG. 7 illustrates a method in accordance with one embodiment of the invention;

FIG. 8 illustrates one embodiment of a qubit index generator for addressing qubits within a quantum processor;

FIG. 9 illustrates a method for determining qubit index values for identifying qubits;

FIG. 10 illustrates an example of a system which decodes and corrects quantum errors;

FIG. 11 illustrates a typical quantum error correction cycle;

FIG. 12 illustrates a quantum control processor (QCP) in accordance with embodiments of the invention;

FIG. 13 illustrates a frontend and a backend of a quantum control processor in accordance with embodiments of the invention; and

FIG. 14 illustrates a method in accordance with embodiments of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Introduction

A quantum computer uses quantum-mechanical phenomena such as superposition and entanglement to perform computations. In contrast to digital computers which store data in one of two definite states (0 or 1), quantum computation uses quantum bits (qbits), which can be in superpositions of states. Qubits may be implemented using physically distinguishable quantum states of elementary particles such as electrons and photons. For example, the polarization of a photon may be used where the two states are vertical polarization and horizontal polarization. Similarly, the spin of an electron may have distinguishable states such as “up spin” and “down spin.”

Qubit states are typically represented by the bracket notations |0 [symbol] and |1 [symbol] . In a traditional computer system, a bit is exclusively in one state or the other, i.e., a ‘0’ or a ‘1.’ However, qbits in quantum mechanical systems can be in a superposition of both states at the same time, a trait that is unique and fundamental to quantum computing.

Quantum computing systems execute algorithms containing quantum logic operations performed on qubits. The sequence of operations is statically compiled into a schedule and the qubits are addressed using an indexing scheme. This algorithm is then executed a sufficiently large number of times until the confidence interval of the computed answer is above a threshold (e.g., ˜95+%). Hitting the threshold means that the desired algorithmic result has been reached.

Qubits have been implemented using a variety of different technologies which are capable of manipulating and reading quantum states. These include, but are not limited to quantum dot devices (spin based and spatial based), trapped-ion devices, superconducting quantum computers, optical lattices, nuclear magnetic resonance computers, solid-state NMR Kane quantum devices, electrons-on-helium quantum computers, cavity quantum electrodynamics (CQED) devices, molecular magnet computers, and fullerene-based ESR quantum computers, to name a few. Thus, while a quantum dot device is described below in relation to certain embodiments of the invention, the underlying principles of the invention may be employed in combination with any type of quantum computer including, but not limited to, those listed above. The particular physical implementation used for qbits is orthogonal to the embodiments of the invention described herein.

### Quantum Dot Devices

Quantum dots are small semiconductor particles, typically a few nanometers in size. Because of this small size, quantum dots operate according to the rules of quantum mechanics, having optical and electronic properties which differ from macroscopic entities. Quantum dots are sometimes referred to as “artificial atoms” to connote the fact that a quantum dot is a single object with discrete, bound electronic states, as is the case with atoms or molecules.

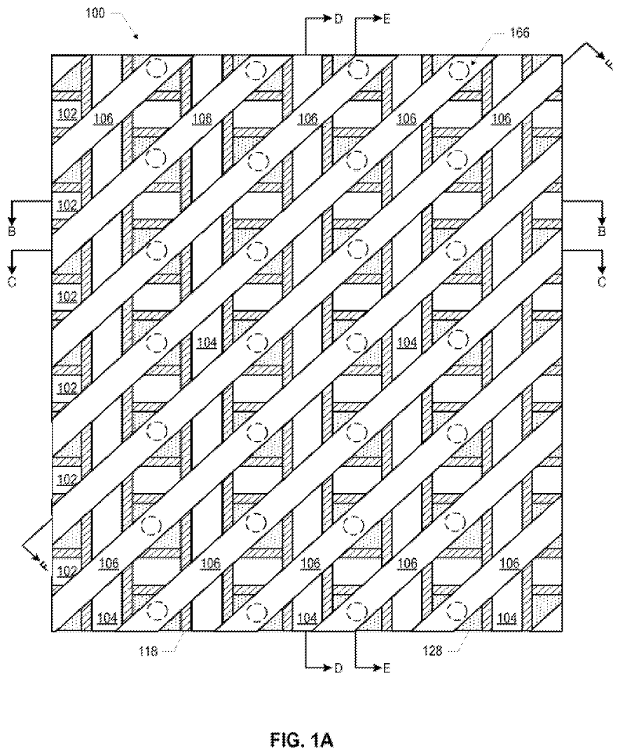

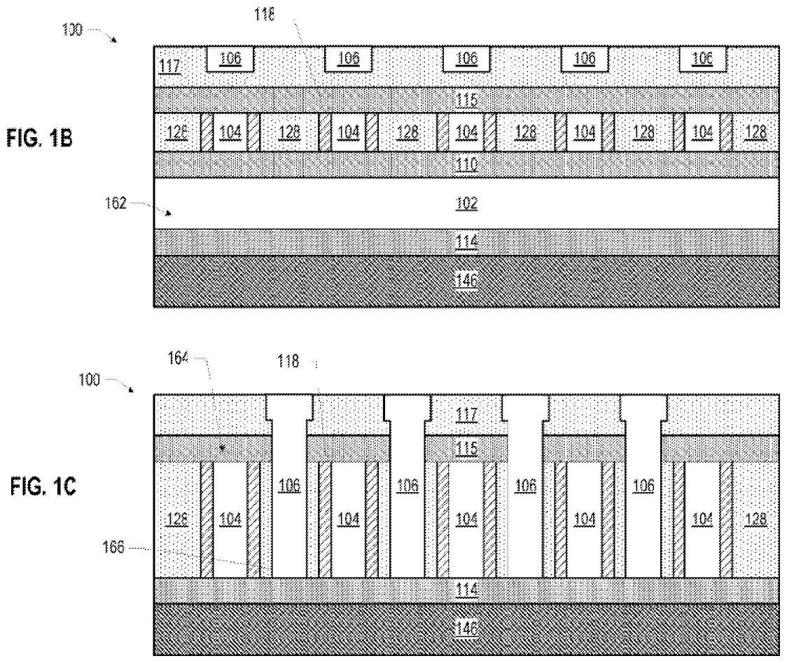

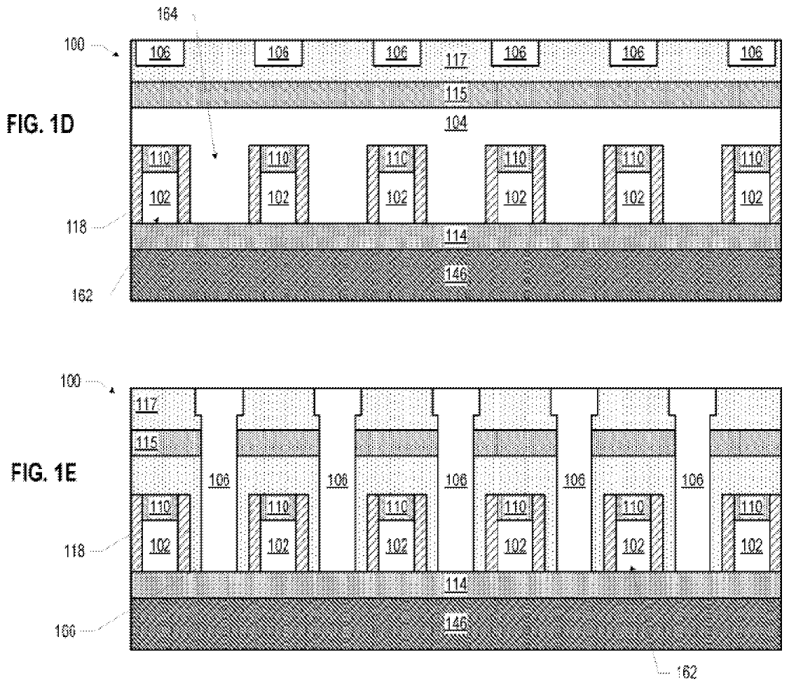

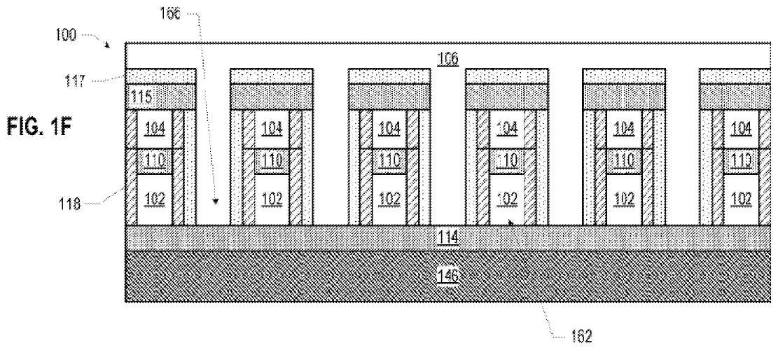

FIGS. 1A-1F are various views of a quantum dot device 100, which may be used with embodiments of the invention described below. FIG. 1A is a top view of a portion of the quantum dot device 100 with some of the materials removed so that the first gate lines 102, the second gate lines 104, and the third gate lines 106 are visible. Although many of the drawings and description herein may refer to a particular set of lines or gates as “barrier” or “quantum dot” lines or gates, respectively, this is simply for ease of discussion, and in other embodiments, the role of “barrier” and “quantum dot” lines and gates may be switched (e.g., barrier gates may instead act as quantum dot gates, and vice versa). FIGS. 1B-1F are side cross-sectional views of the quantum dot device 100 of FIG. 1A; in particular, FIG. 1B is a view through the section B-B of FIG. 1A, FIG. 1C is a view through the section C-C of FIG. 1A, FIG. 1D is a view through the section D-D of FIG. 1A, FIG. 1E is a view through the section E-E of FIG. 1A, and FIG. 1F is a view through the section F-F of FIG. 1A.

The quantum dot device 100 of FIG. 1A may be operated in any of a number of ways. For example, in some embodiments, electrical signals such as voltages, currents, radio frequency (RF), and/or microwave signals, may be provided to one or more first gate line 102, second gate line 104, and/or third gate line 106 to cause a quantum dot (e.g., an electron spin-based quantum dot or a hole spin-based quantum dot) to form in a quantum well stack 146 under a third gate 166 of a third gate line 106. Electrical signals provided to a third gate line 106 may control the electrical potential of a quantum well under the third gates 166 of that third gate line 106, while electrical signals provided to a first gate line 102 (and/or a second gate line 104) may control the potential energy barrier under the first gates 162 of that first gate line 102 (and/or the second gates 164 of that second gate line 104) between adjacent quantum wells. Quantum interactions between quantum dots in different quantum wells in the quantum well stack 146 (e.g., under different quantum dot gates) may be controlled in part by the potential energy barrier provided by the barrier potentials imposed between them (e.g., by intervening barrier gates).

Generally, the quantum dot devices 100 disclosed herein may further include a source of magnetic fields (not shown) that may be used to create an energy difference in the states of a quantum dot (e.g., the spin states of an electron spin-based quantum dot) that are normally degenerate, and the states of the quantum dots (e.g., the spin states) may be manipulated by applying electromagnetic energy to the gates lines to create quantum bits capable of computation. The source of magnetic fields may be one or more magnet lines, as discussed below. Thus, the quantum dot devices 100 disclosed herein may, through controlled application of electromagnetic energy, be able to manipulate the position, number, and quantum state (e.g., spin) of quantum dots in the quantum well stack 146.

In the quantum dot device 100 of FIG. 1, a gate dielectric 114 may be disposed on a quantum well stack 146. A quantum well stack 146 may include at least one quantum well layer 152 (not shown in FIG. 1) in which quantum dots may be localized during operation of the quantum dot device 100. The gate dielectric 114 may be any suitable material, such as a high-k material. Multiple parallel first gate lines 102 may be disposed on the gate dielectric 114, and spacer material 118 may be disposed on side faces of the first gate lines 102. In some embodiments, a patterned hardmask 110 may be disposed on the first gate lines 102 (with the pattern corresponding to the pattern of the first gate lines 102), and the spacer material 118 may extend up the sides of the hardmask 110, as shown. The first gate lines 102 may each be a first gate 162. Different ones of the first gate lines 102 may be electrically controlled in any desired combination (e.g., each first gate line 102 may be separately electrically controlled, or some or all the first gate lines 102 may be shorted together in one or more groups, as desired).

Multiple parallel second gate lines 104 may be disposed over and between the first gate lines 102. As illustrated in FIG. 1, the second gate lines 104 may be arranged perpendicular to the first gate lines 102. The second gate lines 104 may extend over the hardmask 110, and may include second gates 164 that extend down toward the quantum well stack 146 and contact the gate dielectric 114 between adjacent ones of the first gate lines 102, as illustrated in FIG. 1D. In some embodiments, the second gates 164 may fill the area between adjacent ones of the first gate lines 102/spacer material 118 structures; in other embodiments, an insulating material (not shown) may be present between the first gate lines 102/spacer material 118 structures and the proximate second gates 164. In some embodiments, spacer material 118 may be disposed on side faces of the second gate lines 104; in other embodiments, no spacer material 118 may be disposed on side faces of the second gate lines 104. In some embodiments, a hardmask 115 may be disposed above the second gate lines 104. Multiple ones of the second gates 164 of a second gate line 104 are electrically continuous (due to the shared conductive material of the second gate line 104 over the hardmask 110). Different ones of the second gate lines 104 may be electrically controlled in any desired combination (e.g., each second gate line 104 may be separately electrically controlled, or some or all the second gate lines 104 may be shorted together in one or more groups, as desired). Together, the first gate lines 102 and the second gate lines 104 may form a grid, as depicted in FIG. 1.

Multiple parallel third gate lines 106 may be disposed over and between the first gate lines 102 and the second gate lines 104. As illustrated in FIG. 1, the third gate lines 106 may be arranged diagonal to the first gate lines 102, and diagonal to the second gate lines 104. In particular, the third gate lines 106 may be arranged diagonally over the openings in the grid formed by the first gate lines 102 and the second gate lines 104. The third gate lines 106 may include third gates 166 that extend down to the gate dielectric 114 in the openings in the grid formed by the first gate lines 102 and the second gate lines 104; thus, each third gate 166 may be bordered by two different first gate lines 102 and two different second gate lines 104. In some embodiments, the third gates 166 may be bordered by insulating material 128; in other embodiments, the third gates 166 may fill the openings in the grid (e.g., contacting the spacer material 118 disposed on side faces of the adjacent first gate lines 102 and the second gate lines 104, not shown). Additional insulating material 117 may be disposed on and/or around the third gate lines 106. Multiple ones of the third gates 166 of a third gate line 106 are electrically continuous (due to the shared conductive material of the third gate line 106 over the first gate lines 102 and the second gate lines 104). Different ones of the third gate lines 106 may be electrically controlled in any desired combination (e.g., each third gate line 106 may be separately electrically controlled, or some or all the third gate lines 106 may be shorted together in one or more groups, as desired).

Although FIGS. 1A-F illustrate a particular number of first gate lines 102, second gate lines 104, and third gate lines 106, this is simply for illustrative purposes, and any number of first gate lines 102, second gate lines 104, and third gate lines 106 may be included in a quantum dot device 100. Other examples of arrangements of first gate lines 102, second gate lines 104, and third gate lines 106 are possible. Electrical interconnects (e.g., vias and conductive lines) may contact the first gate lines 102, second gate lines 104, and third gate lines 106 in any desired manner.

Not illustrated in FIG. 1 are accumulation regions that may be electrically coupled to the quantum well layer of the quantum well stack 146 (e.g., laterally proximate to the quantum well layer). The accumulation regions may be spaced apart from the gate lines by a thin layer of an intervening dielectric material. The accumulation regions may be regions in which carriers accumulate (e.g., due to doping, or due to the presence of large electrodes that pull carriers into the quantum well layer), and may serve as reservoirs of carriers that can be selectively drawn into the areas of the quantum well layer under the third gates 166 (e.g., by controlling the voltages on the quantum dot gates, the first gates 162, and the second gates 164) to form carrier-based quantum dots (e.g., electron or hole quantum dots, including a single charge carrier, multiple charge carriers, or no charge carriers). In other embodiments, a quantum dot device 100 may not include lateral accumulation regions, but may instead include doped layers within the quantum well stack 146. These doped layers may provide the carriers to the quantum well layer. Any combination of accumulation regions (e.g., doped or non-doped) or doped layers in a quantum well stack 146 may be used in any of the embodiments of the quantum dot devices 100 disclosed herein.

### Apparatus and Method for a Hybrid Classical Quantum Computer

After Richard Feynman asked in 1982 whether quantum physics could be simulated efficiently using a quantum computer, much effort researching for a quantum computer has been focused on its universality and its efficiency over classical computation. One such example is David Deutsch's quantum Turing machine in 1985 that can be programmed to perform any computational task that can be performed by any physical object.

In contrast to theories and algorithms, quantum physical machines are in still their infancy. Efforts to build quantum information processing systems have resulted in modest success to date. Small quantum computers, capable of performing a small set of quantum operations on a very few qubits, represent the state of the art in quantum computation. In addition, quantum states are fragile in the sense that quantum states only remain coherent for a limited duration. This gap between algorithms and physical machines has driven the effort to invent hybrid classical-quantum algorithms. Some recent quantum algorithm developments have focused on short-depth quantum circuits to carry out quantum computations formed as subroutines embedded in a larger classical optimization loop, such as the variational eigensolver (P. J. J. O'Malley, 2016). Quantum languages, tools, and flows have been developed, providing software layers/stacks to translate and optimize applications to the quantum physical layer to cope with the stringent resource constraints in quantum computing (Frederic T. Chong, 2017, 14 Sep.).

On the hardware side, classical computers have been used to perform error correction for quantum computations. The “quantum co-processor” model is the most favorable prevailing execution model where a classical CPU controls a quantum processing unit in a similar manner to how CPUs in modern computer systems interact with GPUs. As described in (X. Fu, 2016 May) and (X. Fu, 2018), the microarchitecture for experimental superconducting quantum co-processors included features such as an arbiter on the code fetch data path to steer classical instruction to host CPU and quantum instruction to quantum co-processor, an exchange register file to synchronize register files between host CPU and the quantum co-processor, and a quantum instruction cache.

The microarchitectures for these mechanisms, however, are not well defined and explicit support for hybrid classical-quantum programs is lacking. Consequently, it is unclear how a quantum co-processor would be implemented within a quantum computer, particularly one which is required to run a diverse set of quantum programs. A flexible and programmable model has yet to be developed for executing hybrid classical-quantum algorithms.

One embodiment of the invention adds a set of quantum instructions to an instruction set architecture (ISA) of a processor such as a CPU. By way of example, these instructions may be included in an extension to the ISA (e.g., such as the AVX-512 extensions for the x86 platform). In addition, in one embodiment, a quantum engine is added to the processor's execution unit and the new quantum instructions are fetched, decoded, scheduled, and executed on the functional units of the quantum engine. In one embodiment, the quantum engine interacts with the classical execution engines using a shared register file and/or system memory. Upon executing the quantum instructions (or quantum uops in certain embodiments described herein), the quantum execution engine generates control signals to manipulate the state of the qubits within the quantum processor. The quantum engine also executes instructions to take a measurement of specified sets of qubits and store the results. In these embodiments, a quantum/classical interface provides connectivity between the quantum engine of the classical processor and the quantum processor.

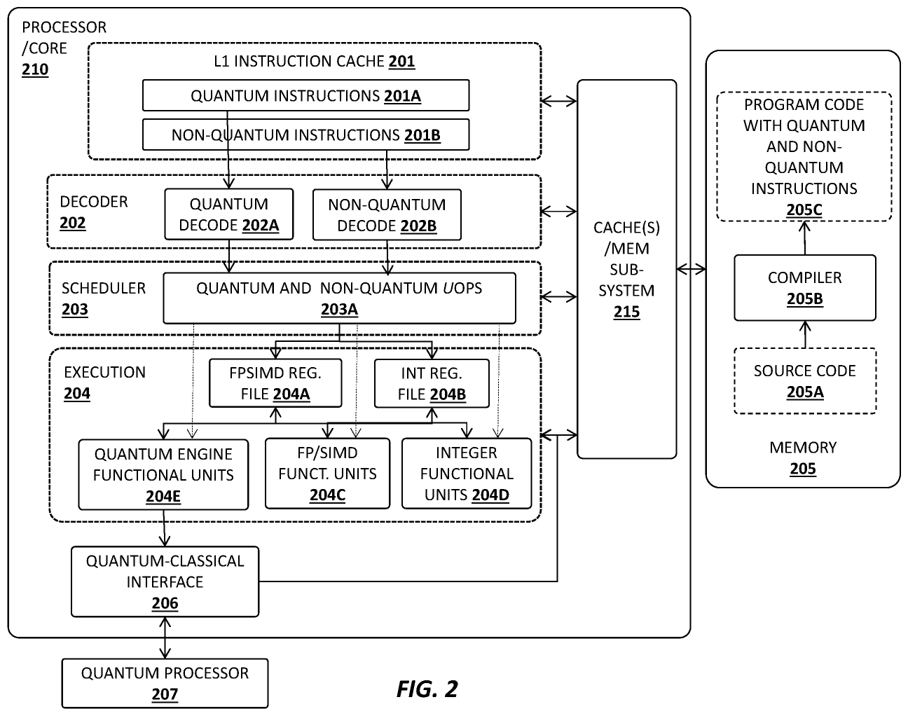

FIG. 2 illustrates one embodiment of a processor or core 210 which fetches, decodes, and executes quantum instructions 201A and non-quantum instructions 201B, utilizing the same pipeline resources as the non-quantum instructions 201B. The processor/core 210 of this embodiment supports quantum extensions to an existing ISA of the processor/core 210 (e.g., extending the ISA to include the quantum instructions 201A). Program code 205C comprising the quantum and non-quantum instructions is generated by a compiler 205B from source code 205A written by a programmer (e.g., utilizing the extended ISA). Various source/program code examples are provided below.

Quantum and non-quantum instructions 201A-B are fetched from memory 205 at the front end of the instruction pipeline and stored in a Level 1 (L1) instruction cache 201. Instructions and data may also be stored within a Level 2 or Level 3 cache within a cache/memory subsystem 215, which manages memory requests and cache coherency.

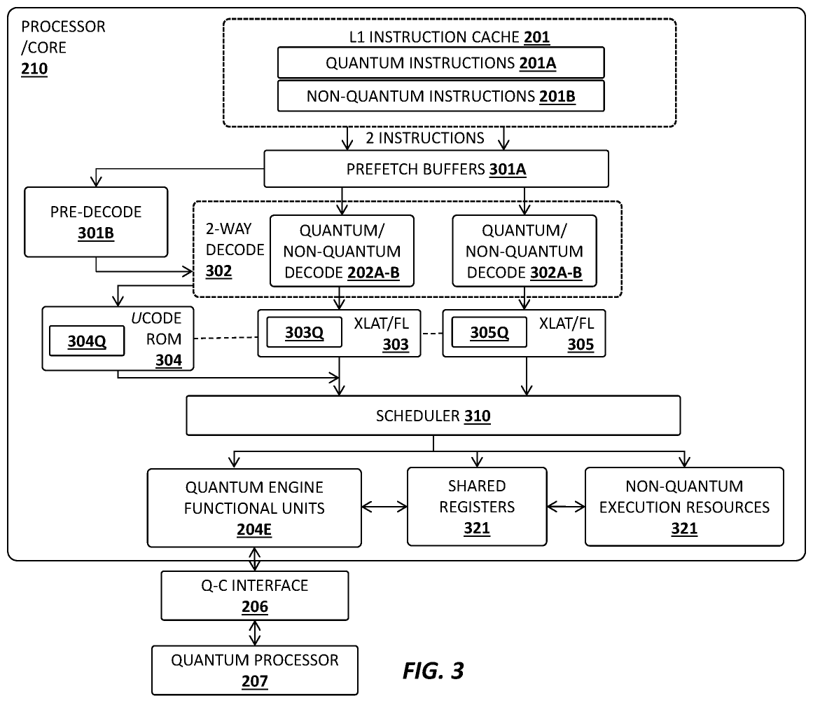

A decoder 202 decodes the instructions 201A-B into microoperations or uops 203A which are scheduled for execution by a scheduler 203 and executed by execution circuitry 204. In one embodiment, certain stages of the pipeline are enhanced to include hardware support for processing the quantum instructions 201B while other stages are unaltered. For example, quantum decode circuitry 202A may be added to the decoder 202 for decoding the quantum instructions 201A, just as non-quantum decode circuitry 202B decodes non-quantum instructions 201B. Although illustrated as separate components in FIG. 2 for the purpose of explanation, the quantum decode circuitry 202A and non-quantum decode circuitry 202B may comprise a common or overlapping set of circuitry and/or microcode. For example, in one embodiment, an existing decoder may be extended to include microcode support for quantum instructions (e.g., in microcode ROM) to generate new sets of quantum uops. The decoder 202 includes other decode circuitry such as a set of decode table structures (see, e.g., FIG. 3 and associated text), depending on the processor architecture.

In one embodiment, the decoder 202 generates a sequence of uops 203A in response to decoding the instructions 201A-B. In an implementation with quantum and non-quantum instructions, the uops may include a mixture of quantum uops and non-quantum uops, which are then scheduled for execution by an instruction scheduler 203.

The quantum and non-quantum uops 203A generated by the decoder 202 may initially be queued for execution within one or more uop queues of the scheduler 203, which dispatches the uops from the uop queue(s) in accordance with dependencies and/or execution resource availability. The embodiments of the invention may be implemented on various different types of processors with different types of schedulers. For example, in one embodiment, a set of execution “ports” couple the scheduler 203 to the execution circuitry 204, where each execution port is capable of issuing uops to a particular set of functional units 204C-E. In the example architecture shown in FIG. 2, for example, SIMD and floating point (FP) uops may be issued by the scheduler 203 over a FP/SIMD execution port coupled to a set of FP/SIMD functional units 204C and integer uops may be issued over an integer port coupled to a set of integer functional units 204D. While only two types of non-quantum functional units are shown for simplicity, the processor/core 210 may include various other/additional non-quantum functional units (e.g., such as load/store address generation units, branch units, additional SIMD and integer units, etc).

In the particular embodiment shown in FIG. 2, the quantum engine functional units 204E share the same set of register files 204A-B used by the legacy processor functional units 204C-D. In this particular example, the register files 204A-B include a FP/SIMD register file 204A which stores floating point and SIMD operands used by the FP/SIMD functional units 204C and an integer register file 204B which stores integer operands for the integer functional units 204D. In one implementation, the FP/SIMD register file 204A comprises 512 bit vector registers and the integer register file 204B comprises 64-bit scalar registers. Of course, different processor architectures will use different types of registers shared by the quantum engine functional units 204E. Various other types of registers may also be used such as a set of control/status registers and mask registers.

In an embodiment in which quantum uops are mixed with non-quantum uops, the quantum uops are issued over one or more quantum ports to a set of quantum engine functional units 204E, which execute the quantum uops to perform the underlying quantum operations. For example, the quantum engine functional units 204E, in response to the quantum uops, may generate control signals over a quantum-classical interface 206 to manipulate and take measurements of the qubits of a quantum processor 207.

The quantum-classical interface 206 includes digital-to-analog (D-A) circuitry to convert the digital quantum control signals generated by the quantum engine functional units 204E to analog signals required to control the quantum processor 207 (e.g., such as the codeword triggered pulse generation (CTPG) units and Arbitrary Waveform Generator (AWG) described below) and also includes analog-to-digital (A-D) circuitry to convert the physical qubit measurements to digital result data.

In one embodiment, the quantum-classical interface 206 is integrated on the same semiconductor chip as the other components of the instruction processing pipeline (e.g., the execution circuitry 204, scheduler 203, decoder 202, etc). As discussed in detail below, different types of circuit/logic components may be used depending on the particular physical implementation of the quantum processor 207.

FIG. 3 illustrates one embodiment in which quantum instruction processing support is added to a low power processing pipeline including a pre-decode buffer 301B, a 2-way decoder 302 with dual sets of quantum/non-quantum decoder circuitry 202A-B, 302A-B, dual lookup tables for instruction translation (XLAT), and a ucode ROM 304. In one embodiment, the XLAT components 303, 305 and ucode ROM 304 are extended to support the quantum instructions, as indicated by logic blocks 303Q-305Q. The pre-decode buffer 301B detects and marks macroinstruction boundaries prior to full decoding into uops by the 2-way decoder 302.

The operands for the quantum and non-quantum uops are stored in a set of shared registers 321 (as described above) and accessed by the quantum functional units 320 when executing the uops. The Q-C interface 320, in response to the quantum uops, controls the operation of the quantum processor 207.

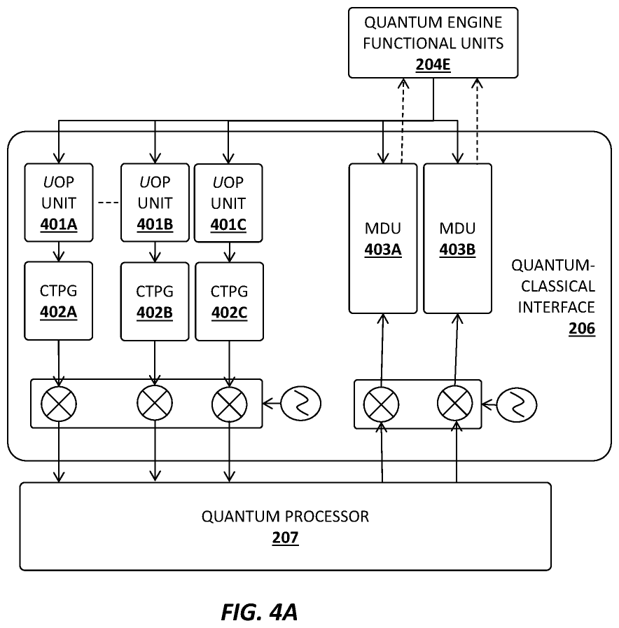

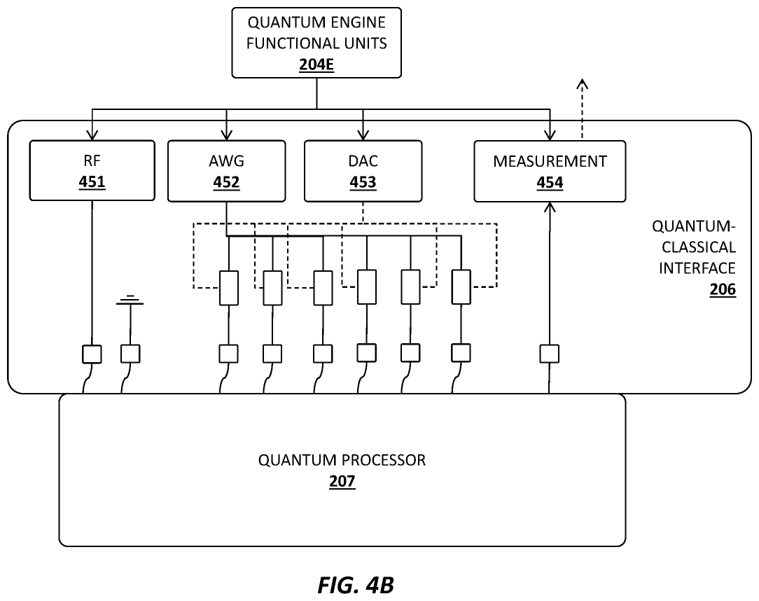

Different examples of a quantum-classical interface 206 are illustrated in FIGS. 4A-B. The Q-C interface 206 in FIG. 4A includes a plurality of uop units 401A-C which, responsive to the uops executed by the quantum engine functional units 204E, generate codewords to control operation of a plurality of codeword triggered pulse generation (CTPG) units 402A-C. In response, the CTPG units 402A-C generate sequences of pulses to control the qubits of the quantum processor 207. Once the quantum processor 207 has reached a specified execution state, quantum measurements are taken by one or more of the measurement discrimination units (MDUs) 403A-B.

The Q-C interface 206 shown in FIG. 4B includes a set of components to perform microwave complex signal generation including an RF microwave unit 451, multi-channel Arbitrary Waveform Generators (AWG) 452, one or more digital to analog converters (DACs) 453 and one or more measurement units 454. In one embodiment, the input to each of these components comprises a set of codewords generated by the quantum engine functional units 204E and the output is an analog waveform which manipulates the state of the qubits of the quantum processor 207. The measurement units 454 measure a current state associated with one or more qubits at a designated point in execution.

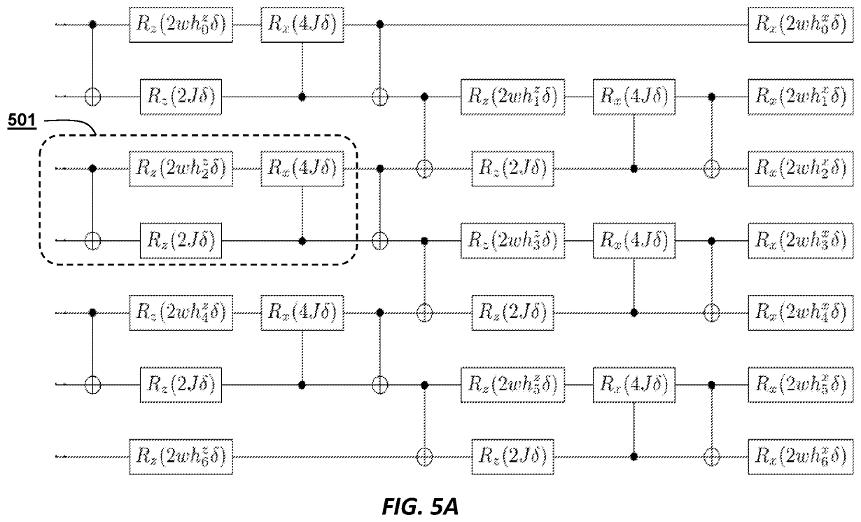

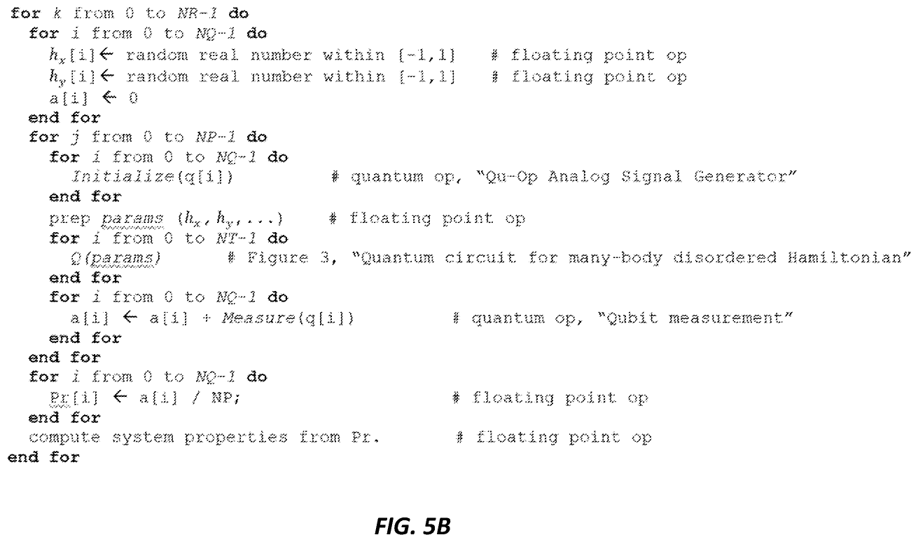

To further guide the analysis and discussion, a concrete example is illustrated in FIG. 5A, which shows a quantum circuit for a many-body disordered Hamiltonian to be time-evolved. Note that the angle through which Rₓ and R_{y} rotate are derived from several parameters. Particularly, hₖ^{z} and hₖ^{x} with k∈{0, 1, . . . , 5, 6} are randomly generated and are used to emulate large many-body systems that require many more number of qubits than what the underlying quantum chip supports.

One example of a quantum program that uses this circuit for a portion of its computation is illustrated in FIG. 5B which includes a mixture of quantum instructions and non-quantum instructions (as indicated by the comments to the right of the source code). In this example, NR is the number of disorder realizations (i.e. multiple small random realizations to emulate a large many-body system), NQ is the number of Qubits, NP is the number of iterations in order to achieve the required precision on Probability (Pr), NT is the number of Trotter steps, and a[i] accumulates Qubit measurement. The probability of qubits being in state |0> or |1> is obtained by repeating measurements (NP) and averaging.

This program structure shows how classical operations and quantum operations may be tightly intertwined and executed on the classical-quantum processing architectures described herein. The most efficient way to execute this program is to process all instructions in a pipeline such as those described above, with the quantum engine functional units 204E for controlling qubits configured as execution engine peer to other classical execution engines 204A-B (such as integer, floating point, etc.).

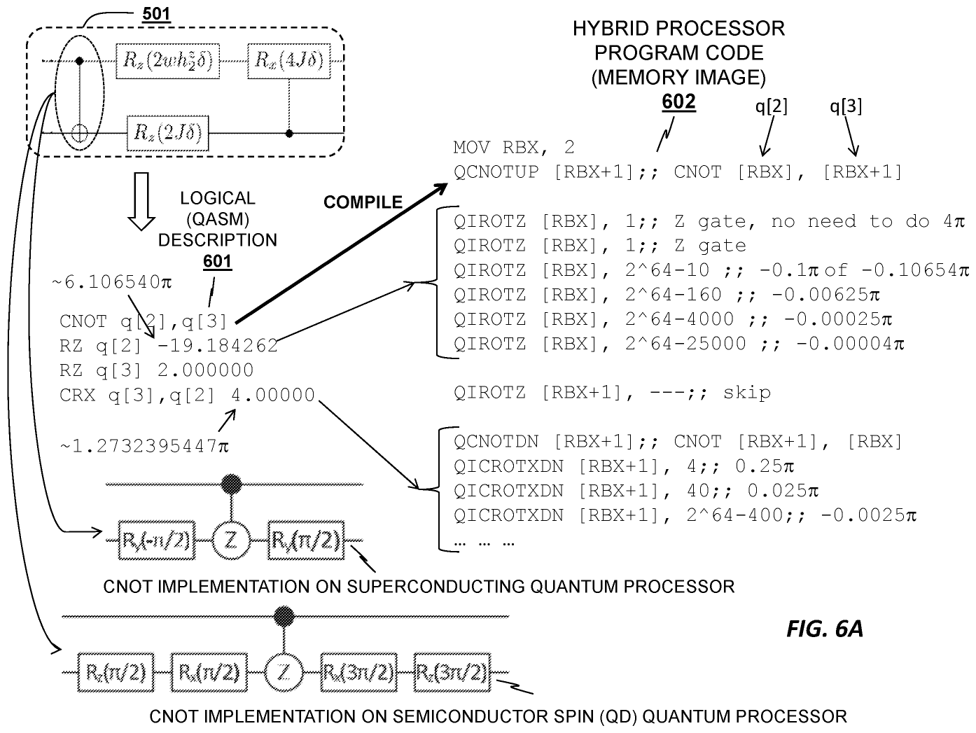

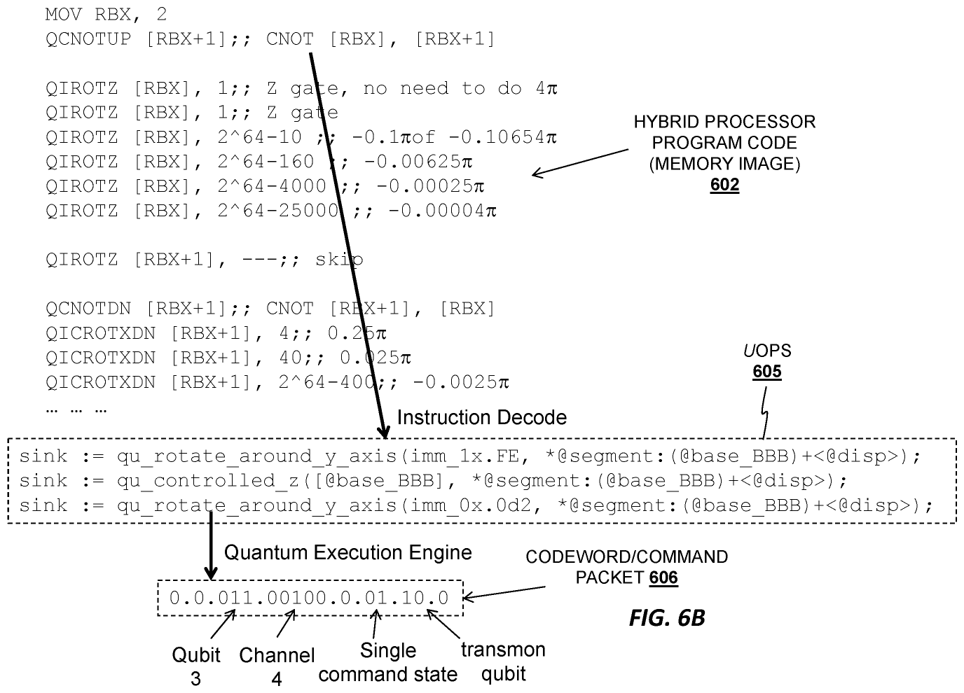

FIGS. 6A-B provide an example of the quantum operations performed in response to the program code in FIG. 5A. In particular, FIG. 6A illustrates a portion of quantum assembly language (QASM) code 601 to implement the highlighted portion 501 of the quantum circuit in FIG. 5A. The QASM code 601 is compiled into hybrid processor program code 602 in memory 205. In this example, the registers RBX and RBX+1 from the shared register file 321 or 204B are used to hold qubit indices to address logical qubits #2 and #3, respectively, in this particular example. The mapping of the relevant portions of the QASM code 601 to the hybrid processor program code 602 is indicated by arrows.

FIG. 6B illustrates how a quantum macroinstruction QCNOTUP (to implement a CNOT gate) is decoded into a series of uops 605 by the decoder 202. The uops 605 are executed by the quantum engine functional units 204E to generate codewords with a specified codeword or command packet format 606. In one particular format, a first data field indicates the qubit on which the operation is to be performed (qubit 3 in the example), a second data field indicates the channel over which the operation is to be transmitted (channel 4), a third field to indicate the command state (e.g., single command state), and a fourth data field to indicate the type of qubit (a transmon qubit). Of course, the underlying principles of the invention are not limited to any particular encoding format.

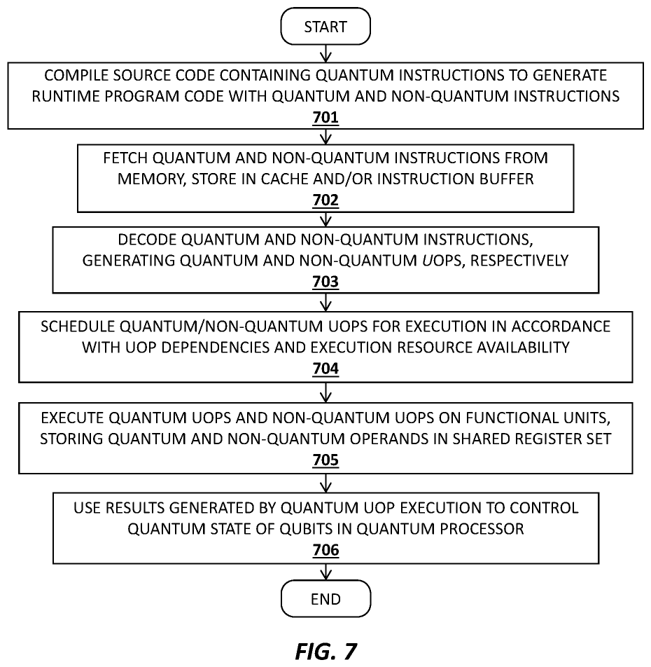

A method in accordance with one embodiment of the invention is illustrated in FIG. 7. The method may be implemented within the context of the processor architectures described above but is not limited to any particular processor or system architecture.

At 701 source code containing quantum instructions is compiled to generate runtime program code with quantum and non-quantum instructions. At 702 the quantum/non-quantum instructions are fetched from memory and stored in a local cache (e.g., the L1 instruction cache) or instruction buffer. As mentioned, quantum instructions may be freely mixed with non-quantum instructions within the pipeline.

At 703 the quantum and non-quantum instructions are decoded into sets of quantum and non-quantum uops, respectively, and stored in a queue prior to execution. At 704 the quantum/non-quantum uops are scheduled for execution based on uop and/or resource dependencies. For example, if a first uop is dependent on the results of a second uop then the first uop may be scheduled for execution only when the data produced by the second uop is available in one of the registers. Similarly, if a particular functional unit is busy, then the scheduler may wait for an indication that the functional unit is available before scheduling a uop which requires that functional unit. Various other/additional scheduling techniques may be implemented (e.g., scheduling based on priority, register load, etc).

At 705 the quantum uops and non-quantum uops are executed on their respective functional units within the execution circuitry. As mentioned, the shared register set may be used to store the source and destination operands required by these uops.

At 706, the results generated by the execution of the quantum uops may be used as input to an interface unit to control the quantum state of the qubits in a quantum processor. In one embodiment, a series of codewords or command packets may be generated which identify a quantum channel, one or more qubits within a quantum processor, a qubit type and/or a command state. The specific physical operations performed in response to the codeword or command packet is based on the underlying type of quantum processor used.

The embodiments described herein integrates quantum instructions within an existing processor pipeline. Because of the tight integration, these embodiments significantly reduces the various overheads/bottlenecks associated with current co-processor designs. These overheads/bottlenecks include, for example, the communication between the classical computation layers/modules and the quantum computation layers/modules in the software stack and between the classical CPU and the quantum chip via the message queue. Given the relatively small size of quantum routines, the current GPU-like co-processor implementations are inefficient.

Due to increased classical processing capabilities, hybrid co-processor models reduce some of the overhead. In one particular implementation which supports the hybrid co-processor model, many new micro-architecture mechanisms were introduced. However, these micro-architectural mechanisms were ambiguously defined as was the boundary between the classical CPU and quantum co-processor.

In contrast, in the hybrid architecture described herein, the classical computation pipeline is equipped to fully support a defined set of quantum instructions which may be freely mixed with non-quantum instructions both at the front end of the pipeline (i.e., at the macroinstruction level) and within the back-end of the pipeline (e.g., where quantum uops are mixed with non-quantum uops) and executed on functional units within the execution circuitry of the processor.

Scalable Qubit Addressing Mode for Quantum Execution Engine and/or Co-Processor

In quantum computing, a qubit is a unit of quantum information which is the quantum analogue of a classical binary bit. The computation is achieved by applying quantum gates, representing quantum logical operations, directly to qubits. Mathematically, this computing process is described as qubits undergo unitary transformations. Upon completion of computation, qubits are measured to gain information about the qubit states.

Therefore, to describe a quantum operation, it is necessary to identify the qubit or set of qubits to which the operation is applied. In a quantum program, each quantum instruction needs to encode both an operation to be performed and one or more qubits on which to perform the operation. In existing quantum instruction set architectures (e.g., QASM, Open QASM, QIS, etc) register operands are normally encoded in the opcode of an instruction. This scheme works for classical computing because the number of registers are very limited (e.g., 16, 32, 64, etc). However, this scheme is not scalable for quantum computing as quantum instructions will ultimately need to address a very large numbers of qubits. Consequently, encoding qubit addresses in the opcode field of quantum instructions would explode the instruction width.

As described above, in one embodiment, quantum instructions and non-quantum instructions are processed together within a shared processor pipeline. As such, the quantum instructions may rely on the same addressing modes as those available to the non-quantum instructions. The qubits in this embodiment are therefore addressed in a similar manner as non-quantum instructions which access system memory, providing a sufficiently large address space to accommodate a large number of qubits.

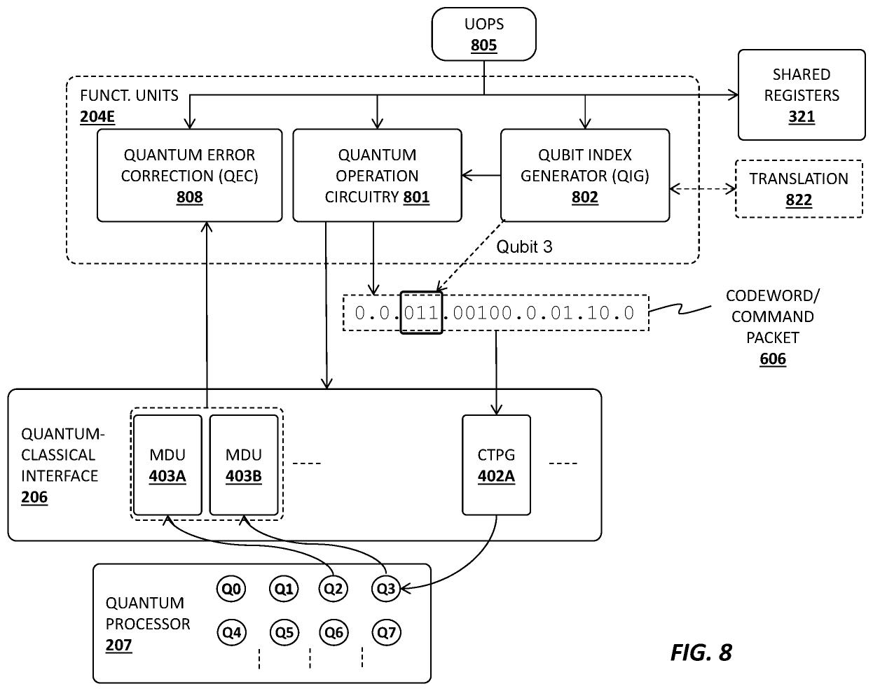

As illustrated in FIG. 8, in this embodiment, the quantum engine functional units 204E include a qubit index generation unit (QIG) 802 which determines a qubit index value or qubit ID in response to one or more uops 805. One or more quantum operation units 801 process the operations specified by the uops. The qubit index value (e.g., 011 for qubit 3 in the example) is then incorporated within the codeword/command packet 606, potentially along with one or more commands generated by the quantum operation unit 801 in response to processing the uops 805.

The QIG 802 may operate in accordance with different addressing modes supported by the processor. In one embodiment, the instruction identifies one of the shared registers 321 which contains the qubit index value (sometimes also referred to as a qubit ID). It may then use the qubit index value to identify the qubit within the codeword/command packet 606 and/or perform an operation using the qubit index value to generate one or more additional qubit index values. For example, it may add the qubit ID value to an integer specified by the uop to generate a second qubit ID.

The following examples demonstrate one way in which the QIG 802 generates qubit IDs in response to uops using an x86 assembly syntax. These operations may be performed within an x86 pipeline extended to support quantum instructions. However, the same general principles may be implemented on any processor architecture.

The single qubit instruction “QIROTX [RDI], 1” applies an X gate to the qubit number stored in RDI. Thus, if RDI contains 5, the X gate is applied to qubit number 5. In this example, the QIG 802 determines the qubit ID simply by reading the value stored in RDI (which is one of the shared registers 321 in this example). In this embodiment, the RDI value was stored previously by another uop. As another example, if the architecture register RBX contains a value of 2, then the two qubit instruction “QCNOTUP [RBX+3],” applies a CNOT operation with qubit 2 (q[2]) being the control qubit and qubit 5 (q[5]) being the target qubit. The QIG interprets the [RBX+3] notation as: the ID of the control qubit is stored in RBX and the ID of the control qubit+3 is the target qubit ID. Thus, the addressing scheme is extended so that two different qubits can be addressed with a single instruction, (i.e., CNOT). In contrast, in classical computing, only one memory location is addressed per instruction.

FIG. 8 also illustrates a codeword triggered pulse generator (CTPG) 402A which includes control logic and an analog-to-digital converter for interpreting the codeword/command packet 606 to identify one or more qubits (Q3 in the example) and generate a sequence of pulses to implement the specified quantum operations. When all of the quantum operations have been performed, as specified by the program code 205C, the quantum operation circuitry 801 and QIG 802 generates a codeword/command packet 606, causing one or more MDUs 403A-B to take a measurement of one or more qubits (as specified by the QIG 802 which generates the qubits indices). As mentioned, the MDUs include analog-to-digital circuitry to convert the analog measurements to digital values, which are then processed by a quantum error correction unit 808 to detect and potentially correct errors. If valid result data has been received it may be stored within one or more of the shared registers 321 and/or accumulated with prior measurement data. In addition to error correction, the measurement can also be used for program flow control based on measurement feedback.

The quantum error correction unit 808 may implement various techniques for detecting and correcting quantum errors. For example, in one embodiment, an error decoder (within the QEC unit 808) decodes a multi-qubit measurement from the quantum processor 207 to determine whether an error has occurred and, if so, implements corrective measures (is possible). The error measurements may be taken from multiple qubits in a manner which does not disturb the quantum information in the encoded state of the qubits (e.g., using ancilla qubits). In response, the QEC unit 808 generates error syndrome data from which it may identify the errors that have occurred and implement corrective operations. In one embodiment, the error syndrome data comprises a stabilizer code such as a surface code. In some cases, the response may simply be to reinitialize the qbits and start over. In other cases, however, modifications to the quantum algorithm implemented in the quantum program code 205C can be made to stabilize the region of the quantum processor responsible for the error (e.g., where compiler 205B includes a just-in-time (JIT) compiler). In either case, the CTPGs 402A perform the underlying physical operations under the control of the codewords/command packets 606 generated by the QEFU 204E. For example, the CTPG 402A may generate electromagnetic pulses to adjust the phase of one or more qbits in accordance with the detected phase error, or to reset the phase/spin of all qbits if re-initialization is required.

Addressing qubits in a manner which is similar to how classical CPU's address memory provides the scalability characteristics/attributes required for future quantum processor implementations. In particular, the above-described embodiments provide qubit indexing which is seamlessly integrated within an existing processor ISA and scales to a large number of qubit systems. These embodiments also remove pressure from the quantum instruction opcode space by way of a quantum extension to x86 or other architectures to address the qubit space and integrate quantum operations to existing processor pipelines.

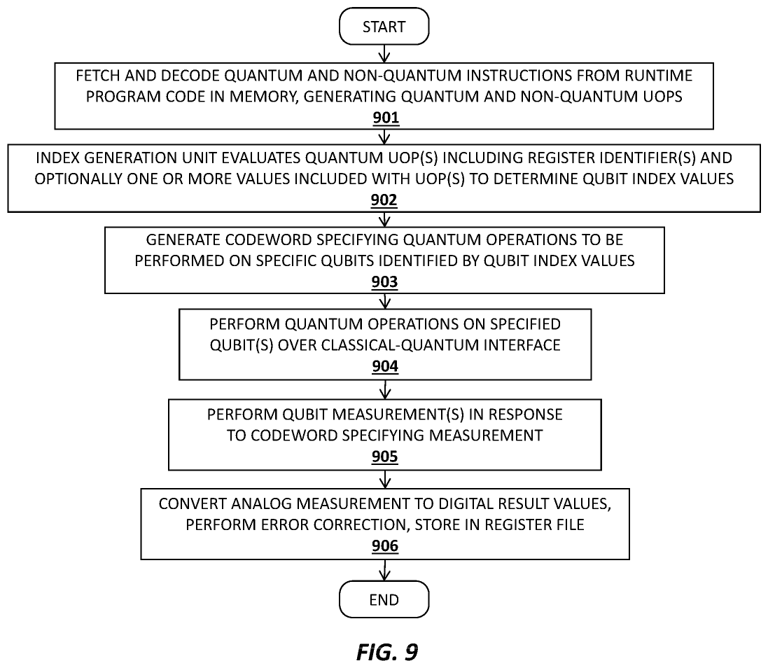

A method in accordance with one embodiment of the invention is illustrated in FIG. 9. The method may be implemented on the architectures described above but is not limited to any particular processor or system architecture.

At 901 quantum and non-quantum instructions from runtime program code are fetched and decoded, generating quantum and non-quantum uops. At 902 an index generation unit evaluates quantum uops including register identifiers and optionally one or more values included with the uops to determine qubit index values. As described above, the indices may be generated using a variety of techniques including reading qubit index values from registers identified by the uops and generating additional qubit index values using integer values included with the uops.

At 903, the quantum execution circuitry generates a codeword specifying the quantum operations to be performed on the qubits identified by the calculated qubit index values. At 904, the quantum operations are performed on the specified qubits. At 905, qubit measurements are performed in response to another codeword generated based on additional uops. At 906, the analog measurement made on one or more of the qubits are converted to digital values. Error correction and/or flow control may then be performed based on the resulted digital result values stored in a register file of the processor.

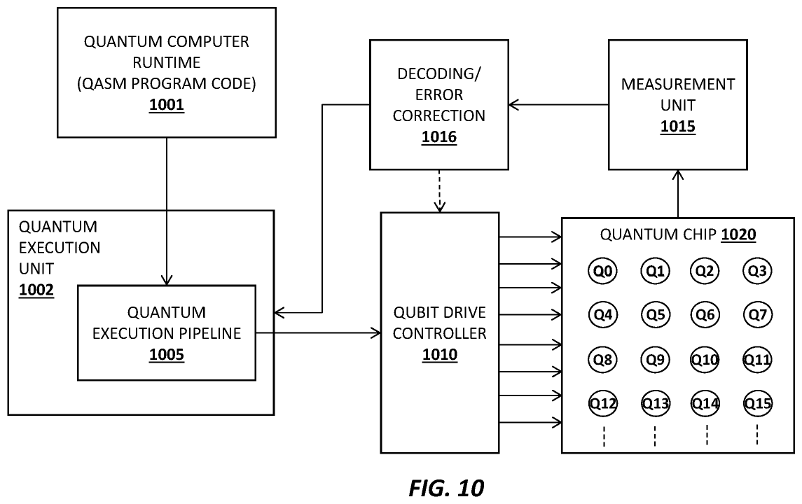

FIG. 10 illustrates a typical quantum computer arrangement with error detection and correction. The illustrated example includes a quantum computer runtime 1001 (e.g., implemented in QASM program code), which is executed by a quantum execution pipeline 1005 of a quantum execution unit 1002. By way of example, and not limitation, the quantum execution unit 1002 may be an application-specific integrated circuit ASIC, a general purpose processor, or a programmable functional unit for executing quantum instructions.

In response to execution of the quantum program code, the quantum execution pipeline 1005 transmits commands to a qubit drive controller 1010 which performs the physical quantum operations on the quantum chip 1020. Depending on the implementation, this may be accomplished by a sequence of RF pulses to manipulate the qubits Q0-Q15 of the quantum chip 1020.

After all or a certain number of program operations have completed, a measurement unit 1015 reads/estimates the quantum state of one or more of the qubits Q0-Q15 and provides the measurement results to a decoding/error correction unit 1016 which decodes the measurements using error correction decoding techniques. For example, the decoding/error correction unit 1016 decodes a multi-qubit measurement from the quantum processor 1020 to determine whether an error has occurred and, if so, implements corrective measures if possible. The error measurements may be taken from multiple qubits in a manner which does not disturb the quantum information in the encoded state of the qubits (e.g., using ancilla qubits). In response, error syndrome data may be generated from which errors and corrective operations may be identified. In one embodiment, the error syndrome data comprises a stabilizer code such as a surface code. In some cases, the response may simply be to reinitialize the qbits Q0-Q15 and start over. In other cases, however, modifications to the quantum algorithm may be implemented in the quantum program code 1001.

The decoded/corrected results are provided to the quantum execution unit 1002 for further processing in accordance with the quantum runtime 1001. The typical operational flow of current quantum computer designs based on a fixed cycle time for each quantum operation executed by the quantum execution pipeline 1005 and each measurement taken by the measurement unit 1015.

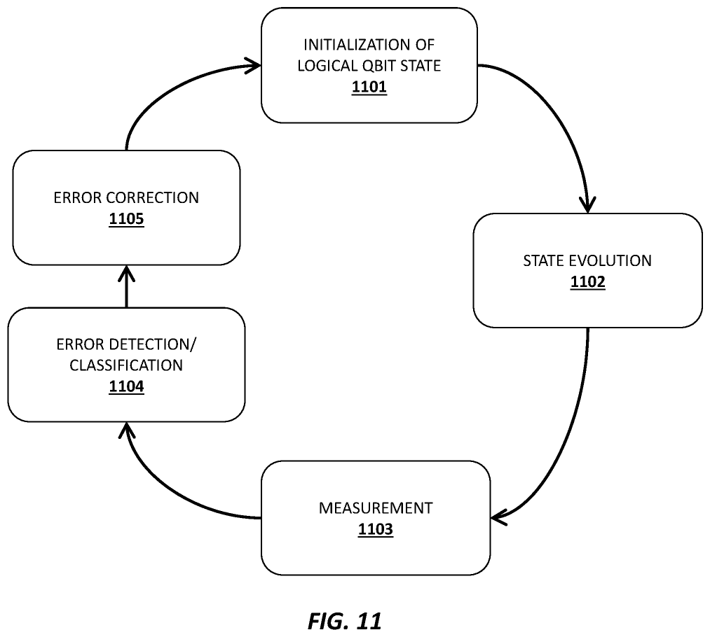

FIG. 11 illustrates one embodiment of a quantum error correction cycle which may be implemented by the architectures described herein. At 1101 the logical qubit state of the system is initialized. For example, if electron spin is used as the quantum state, then electrons within the quantum system may be prepared (e.g., initialized to a particular spin orientation and/or entangled using electromagnetic control signals from the quantum controller).

At 1102, the state of the quantum system evolves in response to additional electromagnetic inputs specified by the quantum runtime 1001 and implemented by the quantum controller 1010. For example, different sets of qubits, including ancilla qubits, may be entangled and manipulated in accordance with the quantum runtime 1001.

At 1103, a measurement of the quantum system is taken. For example, the current spin of one of the entangled electrons may be measured. The system may subsequently be re-initialized prior to the next measurement (i.e., given that taking a measurement or learning any information about the quantum system disrupts the quantum state). The physical qubits may be periodically measured during each error correction cycle.

At 1104 error detection/classification is performed on the measured results to determine whether an error has occurred. The error cycle completes with an error correction operation at 1105 using a specified set of codes, which attempts to correct any detected errors.

### Scalable and Programmable Quantum Control Processor

Many quantum algorithms require a quantum system with a large number of qubits. Moreover, the timing constraints of these quantum systems require many quantum operations to be applied simultaneously on the qubits.

Larger numbers of qubits in a quantum processor results in many challenges, including challenges related to scalability, calibration, performance, parallelism, and error correction. With respect to scalability, for example, there are challenges associated with scaling the control infrastructure of a large quantum chip. For calibration, the challenge is related to transmission of accurate control pulses to qubits given that frequent qubit chip calibration is required. The challenge with respect to performance is related to increasing performance of the execution of the quantum algorithms to meet the timing constraints of the qubits. For error correction, the challenge is related to how error correction should be managed on a shared qubit chip, control electronics, and computational hardware resources.

Embodiments of the invention address these issues in a quantum control processor (QCP) with a scalable and modular architecture to control different quantum systems with large and variable numbers of qubits. The modular QCP controls any number of quantum controllers using a precisely timed and orchestrated sequence of control signals, causing the quantum controllers to generate control pulses to a large number of qubits simultaneously, while implementing error correction and calibration routines. The QCP takes as input a set of instructions of a classical/quantum instruction set architecture, including quantum instructions in accordance with the physical qubit chip technology, and outputs quantum control microcode. In particular, the quantum microcode includes quantum microoperations with an efficient and compact representation of control pulses to realize quantum operations on a target qubit chip.

Quantum systems have stringent timing constraints when performing quantum algorithms because of the short lifetime of the qubits. It is therefore useful in many circumstances to perform quantum operations on qubits simultaneously. When the system scales up, many groups of qubits may need to be controlled concurrently with multiple-qubit controllers (“qControllers”), with each qController comprising multiple quantum control cores (“qCores”). One embodiment of the invention includes a time-aware and scalable quantum control module, referred to herein as the “quantum control processor” or QCP, which is an accelerator in the quantum computing stack that orchestrates a set of qControllers and feeds them with the synchronized digital control pulse signals required to perform quantum operations.

In one embodiment, the quantum control processor works in conjunction with two different classical/quantum instruction sets, mapping the input ISA comprising quantum instructions to the output uISA comprising quantum microinstructions, also referred to as microoperations, and distributing the quantum microoperations to multiple qubit controllers while handling the timing requirements of the specific quantum circuit and control electronics in use.

Briefly, one embodiment of the quantum control processor maintains the synchronization of the quantum operations across the platform; coordinates with the calibration engine to perform calibration routines; utilizes the latest calibration data to generate the digital control pulses per quantum operation; coordinates with the error correction engine to apply error detection and correction circuits; coordinates with multiple qControllers to apply analog pulses to the qubit chip; coordinates with the quantum runtime to process interrupts, different modes of operation, and measurement results from the qubit chip; and implements the communication protocols for shared resources.

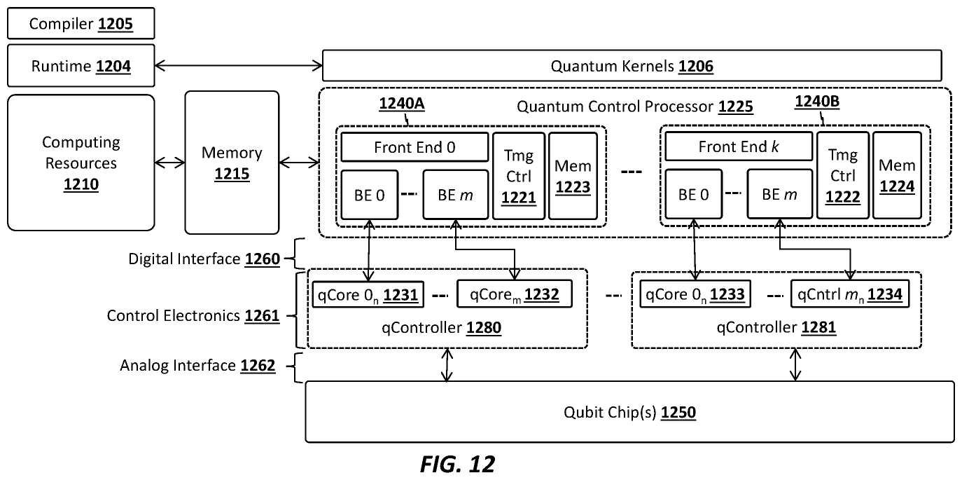

FIG. 12 illustrates an architecture in accordance with some embodiments of the invention. A compiler 1205 and quantum runtime 1204 are executed on classical computing resources 1210 (e.g., an x86 general purpose processor and associated chipset). A memory 1215 coupled to the computing resources 1210 stores the executable program code associated with the compiler 1205 and runtime 1204.

A quantum control processor 1225, also coupled to the memory 1215, executes quantum kernels 1205 (e.g., in accordance classical control flow patterns), which may include both quantum instructions and non-quantum instructions. In the illustrated embodiment, the QCP 1225 includes multiple (k) clusters 1240A-B of functional units, where each cluster includes at least one frontend unit for fetching and decoding instructions of the quantum kernels 1206 (frontend units 0 to k), a plurality of backend units (BE 0 to m) for executing the instructions, a timing controller unit 1221-1222, and a memory 1223-1224.

The illustrated control electronics 1261 comprises a plurality of multi-qubit controllers, qControllers 1280-1281, and each qController 1280-1281 includes a plurality of quantum control cores (qCores) 1231-1232 and 1233-1234, respectively. For example, each qCore may be responsible for executing quantum microcode and responsively controlling one qubit of a qubit chip 1250. In some implementations, each backend unit BE0-BEm is capable of managing and issuing quantum microoperations to at least one of the qCores 1231-1234. In these implementations, each qCore 1231-1234 includes a microcontroller to execute the quantum microoperations and control electronics 1261 to generate analog signals to manipulate a corresponding qubit of the qubit chip 1250.

While the illustrated embodiment includes multiple backend units per frontend unit, other embodiments may include an equal number of backend units and frontend units or more frontend units than backend units per cluster. In one implementation, cluster-level modularity allows QCPs 1206 to be efficiently constructed with different numbers of clusters, based on the specific requirements of each quantum system. In addition, intra-cluster modularity streamlines the design of new clusters with different numbers of backend units, frontend units, timing control units 1221, and local memories 1223. For example, if the frontend of the QCP 1225 becomes a bottleneck when scaling to a large number of qubits, additional frontend modules can be efficiently configured on the QCP. Thus, the modular QCP architecture allows additional modules to be added to the pipeline as needed.

In some embodiments, non-quantum instructions are decoded by one of the frontend units 0-k and executed by an execution unit of one of the backend units 0-m. Quantum instructions are decoded into quantum microoperations by the frontend units 0-k and translated in the backend units 0=m into qController/qCore microoperations (i.e., native microoperations based on the particular qControllers/qCores used; sometimes referred to herein as uqISA), which are dispatched to qCores 1231-1234 over a digital interface 1260. Based on the received uqISA microoperations, a given qCore 1231-1234 generates and applies a corresponding sequence of analog control pulses directed to a qubit of the qubit chips 1250 via the analog interface 1262. The qCores 1231-1234 also take measurements of qubits and provide the measurement results to QCP 1225, which are then passed to the quantum runtime 1204.

The timing controllers 1221-1222 perform time synchronization across multiple QCP frontends and/or backends to ensure that the quantum algorithm is scheduled and executed within the required timing constraints across the large platform. The local memories 1223-1224 may be used to store temporary results during instruction decoding, translation, and execution.

While the QCP 1225 is capable of processing non-quantum instructions, also referred to herein as “classical” instructions, non-quantum tasks or processes which are computationally expensive may be offloaded and run on the computing resources 1210. The decision as to where a particular program code module should be executed may be made by the compiler 1205, runtime 1204 (e.g., by a runtime scheduler), or the QCP 1225.

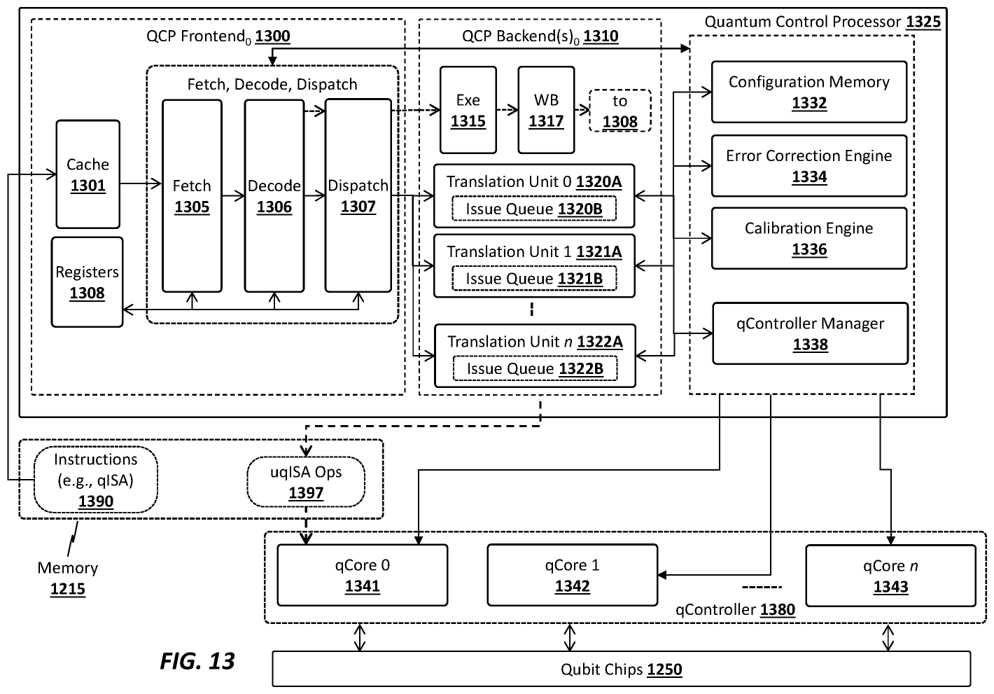

Referring to FIG. 13, one embodiment of the QCP 1325 processes instructions 1390 using a modern microprocessor pipeline architecture with quantum instruction extensions qISA (e.g., an ISA with non-quantum and quantum instructions). In some implementations, quantum instructions are decoded and translated into quantum control microinstructions uqISA designed for a specific qController/qCore type. Since it handles both classical and quantum instructions, certain stages of the pipeline may operate differently than in existing microprocessors.

In FIG. 13 the quantum control processor 1325 includes a frontend 1300 with a cache 1301, a set of registers 1308, fetch logic 1305, decode logic 1306, and dispatch logic 1307. The backend 1310 includes an execution unit 1315, writeback unit 1317 and a set of translation units 1320. The QCP 1325 also includes a configuration memory 1332, error correction engine 1334, calibration engine 1336, and qController manager 1338.

In operation, the fetch logic 1305 fetches quantum and non-quantum instructions 1390 from the cache 1307 and/or memory 1215 and the decode logic 1306 decodes the fetched instructions. While a single instruction cache 1307 is illustrated for both quantum and non-quantum instructions in FIG. 13, separate instruction caches may be used for the quantum and non-quantum instructions.

The decode logic 1306 may include separate decode pipeline stages for quantum and non-quantum instructions. In one embodiment, the decode logic 1306 initially determines whether an instruction is quantum or non-quantum. If the instruction is a quantum instruction, the decoder 1306 identifies the destination qCore 1341-1343 which will execute the corresponding microinstructions. For example, the decoder 1306 may access configuration data related to the set of available qCores 1341-1343 from the configuration memory 1332, and responsively identify a particular qCore. In one implementation, the backend 1310 includes a set of translation units 1320A-1322A with corresponding issue queues 1320A-1322B, each of which is associated with one of the qCores 1341-1343. For example, translation unit 0 1320A may be associated with qCore n 1341, translation unit 1 1321A may be associated with qCore n−1 1342, and so on. Following decoding by the decoder 1306, the dispatch logic 1307 dispatches each decoded quantum instruction to an issue queue 1320B-1322B corresponding to the identified qCore 1341-1343.

The resources to execute each instruction (e.g., execution units, translation units) may be allocated by the dispatch logic 1307 based on the type of instruction. For example, non-quantum instructions are dispatched to a non-quantum issue queue and executed by one or more execution units 1315. The results are stored to registers 1308 or memory 1215 by the writeback stage 1317 (e.g., in accordance with a standard processor pipeline). In contrast, the dispatch unit 1307 dispatches decoded quantum instructions to issue queues 1320B-1322B associated with corresponding qCores 1341-1343.

When dispatching a decoded quantum instruction into one of the issue queues 1320B-1322B, the dispatch logic 1307 is time-aware (e.g., coordinating with one or more of the timing control units 1221-1222) to satisfy the order and the timing dependencies between quantum instructions and to ensure that parallel quantum instructions will execute in sync. To handle the parallelism, there may be multiple backends in a distributed execution cluster architecture (e.g., as described with respect to FIG. 12). In these implementations, all of the backends may be operating in parallel to queue, translate, and issue quantum operations to the qCores 1341-1343.

In one embodiment, translation units 1320A-1322A of each backend translate the microoperations produced by the decoder 1306 (qISA) into the output quantum control microoperations (uqISA). Thus, the translation units effectively perform another layer of decoding-based on the target uqISA. Once the translation complete, the resulting uqISA 1342 microoperations are written to a specific location in memory 1215 allocated for the corresponding qCore 1341-1343 (e.g., in memory 1215 or a local memory 1222-1223, cache, or buffer). In some embodiments, the memory 1215 may be a different memory from that used by the QCP 1325. For example, the memory for storing uqISA operations may be an ultra low power static random access memory (SRAM) or other type of low power memory.

The qController manager 1338 performs power management operations and handles the synchronization across the set of qCores 1341-1343 and qControllers 1380 (e.g., coordinating the issue of microoperations). For example, in one embodiment, the qController manager 1338 notifies the issue logic of the issue queues 1320A-1322A when the qCores are available and/or when the issue logic can write translated microoperations to the memory. Additionally, the qController manager 1338 generates a notification when qubit measurement results are ready.

In one implementation, the analog parameters of the analog control circuitry are stored to the configuration memory 1332 to ensure the proper signals are transmitted over the digital interface 1260 to the qCores 1341-1343. In particular, the translation units 1320A-1322A utilize the data in configuration memory 1332 to decode the qISA microoperations into uqISA microoperations tailored to a specific set of qControllers.

A single backend unit (e.g., backend 1310) can concurrently generate the microoperations for one or more of qCores 1341-1343. For additional scalability, several qCores (e.g., n qCores in one implementation) may be grouped into qController 1380. In this implementation, the quantum control processor 1225, 1325 controls a group of qCores, with each individual qCore controlled by a separate backend unit. The qController manager 1338 may manage all qControllers and corresponding qCores.

Embodiments of the quantum control processor can support different modes of operation based on the underlying physical realization of the qubit chips 1250. To realize this behavior, the QCP 1225, 1325 defines the qISA based on the native gate set supported by one or more target qubit chip(s) 1350. Thus, the compiler 1205 is configured to compile a quantum algorithm/circuit into a sequence of qISA instructions targeting a specific physical quantum chip 1250 and/or backend 1310.

As mentioned, the configuration memory 1332 stores configuration data related to the specific set of qCores 1341-1343 in the system. This can include, for example, the analog parameters of the analog control circuitry and data related to calibration routines and error correction routines implemented by calibration engine and error correction engine 1334, respectively. In one embodiment, the configuration memory 1332 also stores configuration data related to the qubit chip(s) 1250. By way of example, and not limitation, this may include the qubit chip connectivity (i.e., the physical connectivity between qubits) and native gate set implementations and recipes. The configuration memory 1332 may be an on-chip or off-chip memory.

The dispatch logic 1307 in the frontend 1300 is responsible for ensuring that the order of sequential instructions is preserved and, when possible, that the quantum instructions/microoperations are executed in parallel. The dispatch logic 1307 also interacts with other controllers and managers units such as the qController manager 1338 and timing controller units 1221-1222.

The ideal control strategy for each individual quantum gate depends on the characteristics of the underlying types of errors produced by the qubits. In one implementation, the calibration engine 1336 runs programmed calibration routines and updates from the configuration memory 1332 to collect calibration data based on detected errors (e.g., to attempt to maintain the error rate beneath an acceptable threshold). For example, the calibration routines, when executed by the calibration engine 1336, identify the physical properties and capabilities of each of the qubits of the qubit chips 1250, which can then be used to update the control parameters associated with these qubits, which may also be stored in the configuration memory 1332 and used by various stages of the quantum control processor.

The calibration engine 1336 may be configured inside or outside of the QCP 1325, and may perform calibration via a software layer. If configured outside of the QCP 1325, the QCP is still responsible for managing the operation of calibration engine 1336. In one implementation, the calibration engine runs the calibration routines periodically or on demand, based on an interrupt.

The error correction engine 1334 is responsible for performing error correction routines to detect and correct errors when taking measurements from qubits. It may also be configured within or external to the QCP 1325 and may work in combination with a software layer to decode error syndromes. If configured outside of the QCP 1325, then the QCP is still responsible for managing its operation.

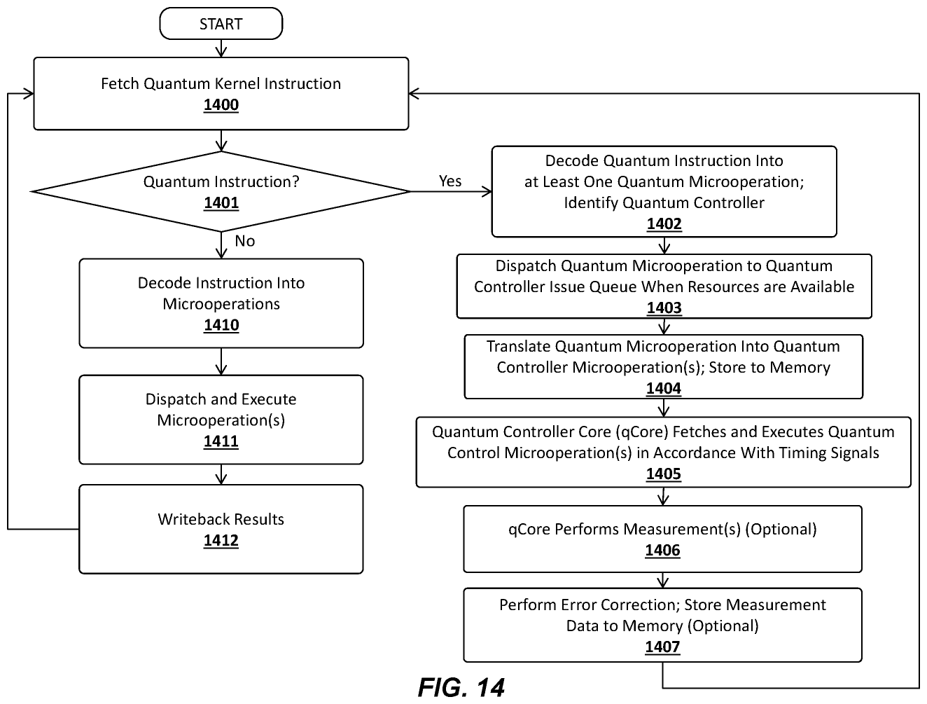

A method in accordance with one embodiment of the invention is illustrated in FIG. 14. The method may be performed on the various architectures described herein, but is not limited to any particular architecture (quantum or classical).

At 1400 an instruction associated with a quantum kernel is fetched (e.g., one of the quantum kernels 1206). At 1401, if the instruction is not a quantum instruction (e.g., an instruction designed to be decoded/translated and executed by a quantum controller), then at 1410, the instruction is decoded into one or more microoperations (sometimes referred to as uops) and, at 1411, the microoperations are dispatched and executed (e.g., on an execution unit). At 1412, results of the microoperations (if any) are written back to registers and/or the memory subsystem (e.g., cache, local memory, system memory, etc).

If, at 1401, the instruction is a quantum instruction, then at 1402, the quantum instruction is decoded into one or more microoperations (e.g., the uISA microoperations described above). As mentioned, quantum instructions may be processed through a different set of decode stages than non-quantum instructions. In addition, a particular quantum controller may be identified at the decode stage (e.g., in combination with configuration data from a configuration memory 1332).

At 1403, the quantum microoperation(s) are dispatched to an issue queue associated with a quantum controller, when an indication is received that sufficient processing resources are available. At 1404, the quantum microoperations are translated into quantum controller microoperations (e.g., uqISA), such as microoperations targeted for execution on a particular qCore or qController. The quantum controller microoperations are stored to a memory or other storage device accessible to the target qCore. At 1405, the qCore, after being notified, fetches and executes the quantum control operations in accordance with set of timing signals (i.e., to ensure that execution occurs at the correct time in relation to the execution of other quantum controller microoperations). The quantum control microoperations, when executed, cause the qCore to generate sequences of analog pulses to manipulate one or more qubits of a quantum processor.

At 1406, the qCore may optionally take measurements of one or more of the qubits (e.g., via measurement discrimination units 403A-B as described above). If measurements are taken, error correction is performed at 1407 and the resulting measurement data is stored to memory, from which it can be combined with other measurement data, read, and analyzed.

The embodiments of the invention address a variety of issues associated with the scalability, calibration, and error correction on quantum systems with many qubits, using a common instruction set to be decoded/translated and consumed by qubit controllers. The quantum control processor (QCP) includes a scalable and modular architecture which provides for control of different quantum systems with large and variable numbers of qubits. The modular QCP controls any number of quantum controllers using a precisely timed and orchestrated sequence of control signals, causing the quantum controllers to generate control pulses to a large number of qubits simultaneously, while implementing error correction and calibration routines. Using an instruction set architecture with quantum extensions as input, these embodiments generate quantum control microcode targeted for the particular quantum controllers and physical qubits of the quantum system.

In the above detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments. Terms like “first,” “second,” “third,” etc. do not imply a particular ordering, unless otherwise specified.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. As used herein, the notation “A/B/C” means (A), (B), and/or (C).

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous.

### Examples

The following are example implementations of different embodiments of the invention.

Example 1. A quantum control processor comprising: a fetch unit to fetch instructions from a memory, the instructions including quantum instructions; a decoder to decode the quantum instructions into a first plurality of quantum microoperations; translation logic translate the first plurality of quantum microoperations into a second plurality of quantum microoperations based on characteristics of a plurality of quantum controller cores coupled to the quantum control processor; and issue logic to synchronously issue the second plurality of quantum microoperations to the plurality of quantum controller cores in parallel.

Example 2. The quantum control processor of example 1 wherein the instructions further include non-quantum instructions, wherein the decoder is to decode the non-quantum instructions into a plurality of non-quantum microoperations, the quantum control processor further comprising: a dispatch unit to dispatch the plurality of non-quantum microoperations to one or more execution units and to dispatch the first plurality of quantum microoperations to the translation logic.

Example 3. The quantum control processor of examples 1 or 2 wherein the translation logic comprises a plurality of translation units, each translation unit associated with a quantum controller core of the plurality of quantum controller cores and configured to translate one or more of the first plurality of quantum microoperations into one or more of the second plurality of quantum microoperations for execution by the quantum controller core.

Example 4. The quantum control processor of any of examples 1-3, wherein the issue logic comprises a plurality of issue queues, each issue queue corresponding to a translation unit of the plurality of translation units and configured to store the one or more quantum microoperations of the first plurality of quantum microoperations or an indication of the one or more quantum microoperations of the first plurality of quantum microoperations.

Example 5. The quantum control processor of any of examples 1-4, further comprising: a configuration memory to store configuration data related to the characteristics of the plurality of quantum controller cores, wherein the decoder is read the configuration data to identify a first quantum controller core of the plurality of quantum controller cores to execute one or more microoperations of the second plurality of quantum microoperations associated with a first instruction of the plurality of quantum instructions.

Example 6. The quantum control processor of any of examples 1-5 further comprising: a calibration engine to execute one or more calibration routines to generate at least a portion of the configuration data.

Example 7. The quantum control processor of any of examples 1-6 further comprising at least one of a modular front end unit comprising the fetch unit and decoder and a modular back end unit comprising the translation logic and issue logic, the quantum control processor further comprising: a modular interface to couple a variable number of modular front end units or modular back end units.

Example 8. The quantum control processor of any of examples 1-7 further comprising: a modular cluster comprising a front end unit and zero or more additional front end units and a back end unit and zero or more additional back end units.

Example 9. The quantum control processor of any of examples of 1-8 wherein the translation logic is to store the second plurality of quantum microoperations in a memory, the quantum control processor further comprising: a quantum controller manager to communicate with the issue logic to cause the plurality of quantum controller cores to access a respective portion of the second plurality of quantum microoperations from a respective region of the memory.

Example 10. The quantum control processor of any of examples 1-9 further comprising: timing circuitry coupled to the issue logic and the quantum controller manager, the issue logic and/or the quantum controller manager to access the timing circuitry to synchronously issue the second plurality of quantum microoperations in parallel to the plurality of quantum controller cores.

Example 11. A method comprising: fetching instructions from a memory, the instructions including quantum instructions; decoding the quantum instructions into a first plurality of quantum microoperations; translating the first plurality of quantum microoperations into a second plurality of quantum microoperations based on characteristics of a plurality of quantum controller cores; and synchronously issuing the second plurality of quantum microoperations to the plurality of quantum controller cores in parallel.

Example 12. The method of example 11 wherein the instructions further include non-quantum instructions, wherein the decoder is to decode the non-quantum instructions into a plurality of non-quantum microoperations, the method further comprising: dispatching the plurality of non-quantum microoperations to one or more execution units and dispatching the first plurality of quantum microoperations to the translation logic.

Example 13. The method of examples 11 or 12 wherein the translating further comprises performing a plurality of separate translations at least partially in parallel, each translation of the plurality of separate translations associated with a different portion of the first plurality of quantum microoperations and a quantum controller core of the plurality of quantum controller cores.

Example 14. The method of any of examples 11-13, wherein synchronously issuing the second plurality of quantum microoperations to the plurality of quantum controller cores in parallel further comprises storing each of the different portions of the first plurality of quantum microoperations or an indication of each of the different portions in a separate issue queue, each issue queue associated with a quantum controller core of the plurality of quantum controller cores.

Example 15. The method of any of examples 11-14, further comprising: storing configuration data related to the characteristics of the plurality of quantum controller cores, reading the configuration data to identify a first quantum controller core of the plurality of quantum controller cores to execute one or more microoperations of the second plurality of quantum microoperations associated with a first instruction of the plurality of quantum instructions.

Example 16. The method of any of examples 11-15 further comprising: executing one or more calibration routines to generate at least a portion of the configuration data.

Example 17. The method of any of examples 11-16 further comprising: storing the second plurality of quantum microoperations in a memory, causing the plurality of quantum controller cores to access a respective portion of the second plurality of quantum microoperations from a respective region of the memory.

Example 18. A quantum system comprising: a memory to store instructions associated with a quantum runtime, a host processor to execute the instructions to implement the quantum runtime; a quantum control processor coupled to the memory, the quantum control processor comprising: a fetch unit to fetch instructions from a memory, the instructions including quantum instructions; a decoder to decode the quantum instructions into a first plurality of quantum microoperations; translation logic translate the first plurality of quantum microoperations into a second plurality of quantum microoperations based on characteristics of a plurality of quantum controller cores coupled to the quantum control processor; and issue logic to synchronously issue the second plurality of quantum microoperations to the plurality of quantum controller cores in parallel.

Example 19. The quantum system of example 18 wherein the instructions further include non-quantum instructions, wherein the decoder is to decode the non-quantum instructions into a plurality of non-quantum microoperations, the quantum system further comprising: a dispatch unit to dispatch the plurality of non-quantum microoperations to one or more execution units and to dispatch the first plurality of quantum microoperations to the translation logic.

Example 20. The quantum system of examples 18 or 19 wherein the translation logic comprises a plurality of translation units, each translation unit associated with a quantum controller core of the plurality of quantum controller cores and configured to translate one or more of the first plurality of quantum microoperations into one or more of the second plurality of quantum microoperations for execution by the quantum controller core.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

What is claimed is:

1. A quantum control processor comprising:
instruction fetch logic to fetch instructions from a memory, the instructions including quantum instructions;
decode logic to decode the quantum instructions into a first plurality of quantum microoperations;
translation logic to translate the first plurality of quantum microoperations into a second plurality of quantum microoperations based on characteristics of a plurality of quantum controller cores coupled to the quantum control processor; and
issue logic to synchronously issue the second plurality of quantum microoperations to the plurality of quantum controller cores in parallel.

2. The quantum control processor of claim 1 wherein the instructions further include non-quantum instructions, wherein the decode logic is to decode the non-quantum instructions into a plurality of non-quantum microoperations, the quantum control processor further comprising:
dispatch logic to dispatch the plurality of non-quantum microoperations to one or more execution units and to dispatch the first plurality of quantum microoperations to the translation logic.

3. The quantum control processor of claim 1 wherein the translation logic comprises a plurality of translation units, each translation unit associated with a quantum controller core of the plurality of quantum controller cores and configured to translate one or more of the first plurality of quantum microoperations into one or more of the second plurality of quantum microoperations for execution by the quantum controller core.

4. The quantum control processor of claim 3, wherein the issue logic comprises a plurality of issue queues, each issue queue corresponding to a translation unit of the plurality of translation units and configured to store the one or more quantum microoperations of the first plurality of quantum microoperations or an indication of the one or more quantum microoperations of the first plurality of quantum microoperations.

5. The quantum control processor of claim 1, further comprising:
a configuration memory to store configuration data related to the characteristics of the plurality of quantum controller cores,
wherein the decode logic is to read the configuration data to identify a first quantum controller core of the plurality of quantum controller cores to execute one or more microoperations of the second plurality of quantum microoperations associated with a first instruction of the plurality of quantum instructions.

6. The quantum control processor of claim 5 further comprising:
calibration logic to execute one or more calibration routines to generate at least a portion of the configuration data.

7. The quantum control processor of claim 1 further comprising at least one of a modular front end unit comprising the instruction fetch logic and decode logic and a modular back end unit comprising the translation logic and issue logic, the quantum control processor further comprising:
a modular interface to couple a variable number of modular front end units or modular back end units.

8. The quantum control processor of claim 1 further comprising:
a modular cluster comprising a front end unit and zero or more additional front end units and a back end unit and zero or more additional back end units.

9. The quantum control processor of claim 1 wherein the translation logic is to store the second plurality of quantum microoperations in a memory, the quantum control processor further comprising:
a quantum controller manager to communicate with the issue logic to cause the plurality of quantum controller cores to access a respective portion of the second plurality of quantum microoperations from a respective region of the memory.

10. The quantum control processor of claim 9 further comprising:
timing circuitry coupled to the issue logic and the quantum controller manager, the issue logic and/or the quantum controller manager to access the timing circuitry to synchronously issue the second plurality of quantum microoperations in parallel to the plurality of quantum controller cores.

11. A method comprising:
fetching instructions from a memory, the instructions including quantum instructions;
decoding the quantum instructions into a first plurality of quantum microoperations;
translating the first plurality of quantum microoperations into a second plurality of quantum microoperations based on characteristics of a plurality of quantum controller cores; and
synchronously issuing the second plurality of quantum microoperations to the plurality of quantum controller cores in parallel.

12. The method of claim 11 wherein the instructions further include non-quantum instructions, wherein the decode logic is to decode the non-quantum instructions into a plurality of non-quantum microoperations, the method further comprising:
dispatching the plurality of non-quantum microoperations to one or more execution units and dispatching the first plurality of quantum microoperations to the translation logic.

13. The method of claim 11 wherein the translating further comprises performing a plurality of separate translations at least partially in parallel, each translation of the plurality of separate translations associated with a different portion of the first plurality of quantum microoperations and a quantum controller core of the plurality of quantum controller cores.

14. The method of claim 13, wherein synchronously issuing the second plurality of quantum microoperations to the plurality of quantum controller cores in parallel further comprises storing each of the different portions of the first plurality of quantum microoperations or an indication of each of the different portions in a separate issue queue, each issue queue associated with a quantum controller core of the plurality of quantum controller cores.

15. The method of claim 11, further comprising:
storing configuration data related to the characteristics of the plurality of quantum controller cores,
reading the configuration data to identify a first quantum controller core of the plurality of quantum controller cores to execute one or more microoperations of the second plurality of quantum microoperations associated with a first instruction of the plurality of quantum instructions.

16. The method of claim 15 further comprising:
executing one or more calibration routines to generate at least a portion of the configuration data.

17. The method of claim 11 further comprising:
storing the second plurality of quantum microoperations in a memory,
causing the plurality of quantum controller cores to access a respective portion of the second plurality of quantum microoperations from a respective region of the memory.

18. A quantum system comprising:
a memory to store instructions associated with a quantum runtime,
a host processor to execute the instructions to implement the quantum runtime;
a quantum control processor coupled to the memory, the quantum control processor comprising:
instruction fetch logic to fetch instructions from the memory, the instructions including quantum instructions;
decode logic to decode the quantum instructions into a first plurality of quantum microoperations;
translation logic translate the first plurality of quantum microoperations into a second plurality of quantum microoperations based on characteristics of a plurality of quantum controller cores coupled to the quantum control processor; and
issue logic to synchronously issue the second plurality of quantum microoperations to the plurality of quantum controller cores in parallel.

19. The quantum system of claim 18 wherein the instructions further include non-quantum instructions, wherein the decode logic is to decode the non-quantum instructions into a plurality of non-quantum microoperations, the quantum system further comprising:
dispatch logic to dispatch the plurality of non-quantum microoperations to one or more execution units and to dispatch the first plurality of quantum microoperations to the translation logic.

20. The quantum system of claim 18 wherein the translation logic comprises a plurality of translation units, each translation unit associated with a quantum controller core of the plurality of quantum controller cores and configured to translate one or more of the first plurality of quantum microoperations into one or more of the second plurality of quantum microoperations for execution by the quantum controller core.
